(19) United States
(12) Patent Application Publication
(10) Pub. No.: US 2016/0246466 A1
(43) Pub. Date: Aug. 25, 2016

(54) TRANSPARENT FULL-SCREEN TEXT ENTRY INTERFACE

(71) Applicant: NUANCE COMMUNICATIONS, INC., Burlington, MA (US)

(72) Inventors: Gordon Waddell, Seattle, WA (US); Steven Mattox, Seattle, WA (US); David J. Kay, Seattle, WA (US)

(21) Appl. No.: 14/629,428

(22) Filed: Feb. 23, 2015

(51) Int. Cl. G06F 3/0484; G06F 3/023

(52) U.S. Cl. CPC G06F 3/0484; G06F 3/0237

(57) ABSTRACT

A method and system for generating a transparent or semi-transparent full-screen text entry interface for mobile devices. The interface provides a user of a mobile computing device with a full-screen interface, the text entry layer, used to input text into an application or operating system (OS), while enabling the user to still see and interact with the application or OS (the application layer). One of the text entry layer and application layer is active at a time; touch inputs to the device are attributed exclusively to the active layer. When active, the text entry layer is displayed over the application layer. The system handles switching between active and inactive states for the text entry layer and application layer. The system further provides visual cues that indicate which of the application layer and text entry layer is currently the active layer.

### BACKGROUND

Mobile computing devices, such as wearable computers and mobile phones, present substantial user interface challenges. Because of the popularity of touchscreens and concerns with overall size, mobile devices typically omit physical keyboards and instead rely on touchscreen-based interfaces, such as an on-screen keyboard, for accepting user input. Unfortunately, on-screen interfaces may interfere with device usability. For example, users often prefer that an application be displayed while the on-screen keyboard is active, so that the user can receive feedback regarding their keyboard input or so that the user can interact with elements of the application. Thus a portion of the touchscreen area is allocated to displaying an application (which may have interactive elements) and another portion allocated to displaying an on-screen keyboard.

As mobile devices get smaller and screen sizes decrease, the available screen area for the on-screen keyboard and application is reduced. Smaller screens can create problems with accurately detecting user input, make it difficult for a user to read what is being displayed on-screen, or both. As a result, designers have continued to innovate and seek user interfaces that offer improved usability.

### BRIEF DESCRIPTION OF THE DRAWINGS

FIG. 1 is a diagram of an example environment in which a mobile computing device with a transparent full-screen text entry interface may operate.

FIG. 2 is a block diagram illustrating an example of a mobile computing device that implements a transparent full-screen text entry interface.

FIG. 3 is a flow diagram depicting a process flow for activating a transparent full-screen text entry interface, receiving text through the transparent interface, receiving interactions with elements of an application while the transparent interface is active, and exiting the transparent interface.

FIG. 4A is an example screen capture of an activated transparent full-screen text entry interface in which the transparent interface receives input via a 9-key keypad.

FIG. 4B is another example screen capture of an activated transparent full-screen text entry interface in which the transparent interface receives input via handwriting recognition.

FIG. 4C is a further example screen capture of an activated transparent full-screen text entry interface in which feedback to the user indicating the transparent interface is active includes banner text and an icon.

### DETAILED DESCRIPTION

A method and system for generating a transparent full-screen text entry interface is described herein. The transparent full-screen text entry interface provides a user of a mobile computing device with a full-screen interface to input text into a text field of an application or operating system (OS), while enabling the user to still see and interact with the application or OS. The system launches a transparent or semi-transparent full-screen text entry interface in response to a user selecting a text entry field within an application or OS on a mobile computing device. The text entry layer is a transparent full-screen layer used for text entry, and conceptually overlays the application or OS layer (hereinafter collectively referred to as the “application layer”), which continues to display the application or OS feature the user was previously interacting with. The system designates one layer the active layer and the other layer the inactive layer; touch inputs to the device are attributed exclusively to the active layer. When activated, the text entry layer is designated the active layer. User input to the text entry layer is interpreted as text and passed to the text entry field in the application layer. In some embodiments the transparent text entry layer includes opaque interface elements. For example, the text entry layer may include opaque keys of a 9-key keypad, through which the user can enter text. In other embodiments the text entry layer recognizes user strokes as handwriting and converts those strokes to text. The display of the inactive layer continues to update in response to user interaction with the active layer. When the text entry layer is active, user-entered text is therefore displayed in the text entry field of the inactive application layer as the user interacts with the text entry layer. An advantage of the transparent full-screen text entry interface is that the entire display can be used by the text entry layer, which allows for more accurate user input despite smaller display sizes, while maintaining a visible application layer.

The system also handles switching between active and inactive states for the application layer and text entry layer. While the text entry layer is active, the user may need to interact with the application layer, for instance to move a cursor in the text entry field or to interact with a user interface element. To interact with the application layer the user enters a command via the transparent full-screen text entry interface that promotes the application layer to the active layer and demotes the text entry layer to the inactive layer. In some embodiments the user uses a swipe gesture to indicate the active layer switch. In other embodiments the user performs a long press. In still other embodiments the user uses an input other than through the text entry interface, such as a physical key on the mobile computing device (e.g., a dedicated button or a function key), a touch-sensitive panel other than the display, or voice commands, to indicate the active layer switch. Once the application layer is made the active layer, it is displayed in lieu of the text entry layer and registers user inputs. In some embodiments the user restores the text entry layer as the active layer with a second command. In other embodiments the system automatically restores the text entry layer as the active layer after an elapsed period during which no user input is registered. In some embodiments the elapsed period is a half-second. The user may also exit the transparent full-screen text entry interface, which closes the text entry layer and resumes the application layer, with a third command. In some embodiments the system closes the transparent interface after a timeout, longer than the brief timeout, during which no user input is registered.

The system further provides visual cues that indicate which of the application layer and text entry layer is currently the active layer. In some embodiments the inactive layer, displayed in the background, is modified to appear faded. In other embodiments the inactive layer is slightly blurred. In still other embodiments the active layer includes an icon or banner that indicates which layer is active. For example, when the text entry layer is active the system may display a small icon with the text “KB”, for keyboard, to indicate the text entry layer is active.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in details, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Suitable Environments

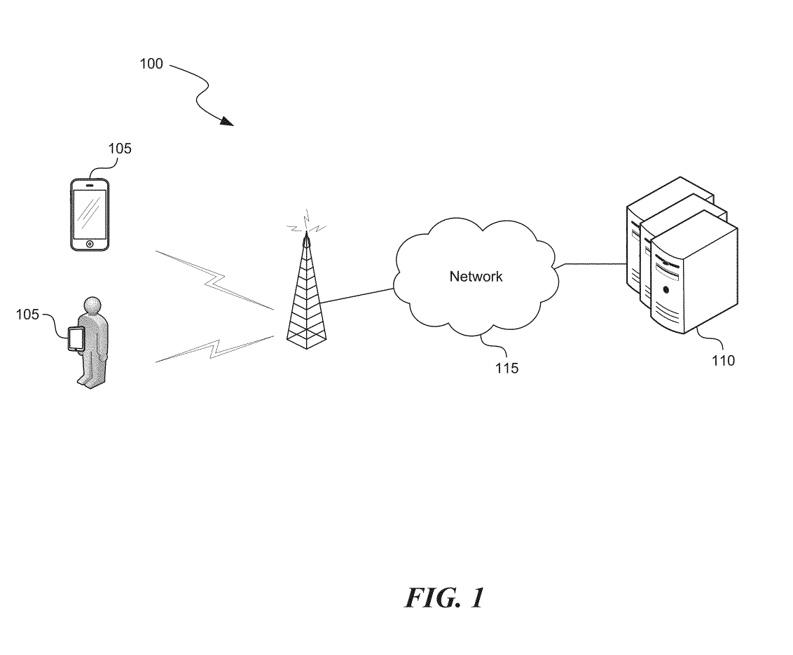

FIG. 1 and the following discussion provide a brief, general description of a suitable computing environment 100 in which a system to generate a transparent full-screen text entry interface can be implemented. Although not required, aspects and implementations of the invention will be described in the general context of computer-executable instructions, such as routines executed by a general-purpose computer, a personal computer, a server, or other computing system. The invention can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a representative environment 100 in which aspects of the described technology may operate includes one or more mobile computing devices 105 and server computers 110. A mobile computing device 105 may be a mobile phone, tablet, phablet, or may be a wearable computer, such as a smartwatch.

The mobile computing devices 105 communicate with each other and the servers 110 through networks 115, including, for example, the Internet. The mobile computing devices 105 communicate wirelessly with a base station or access point using a wireless mobile telephone standard, such as the Global System for Mobile Communication (GSM), or another wireless standard, such as IEEE 802.11, and the base station or access point communicates with the server 110 via the networks 115.

### Suitable System

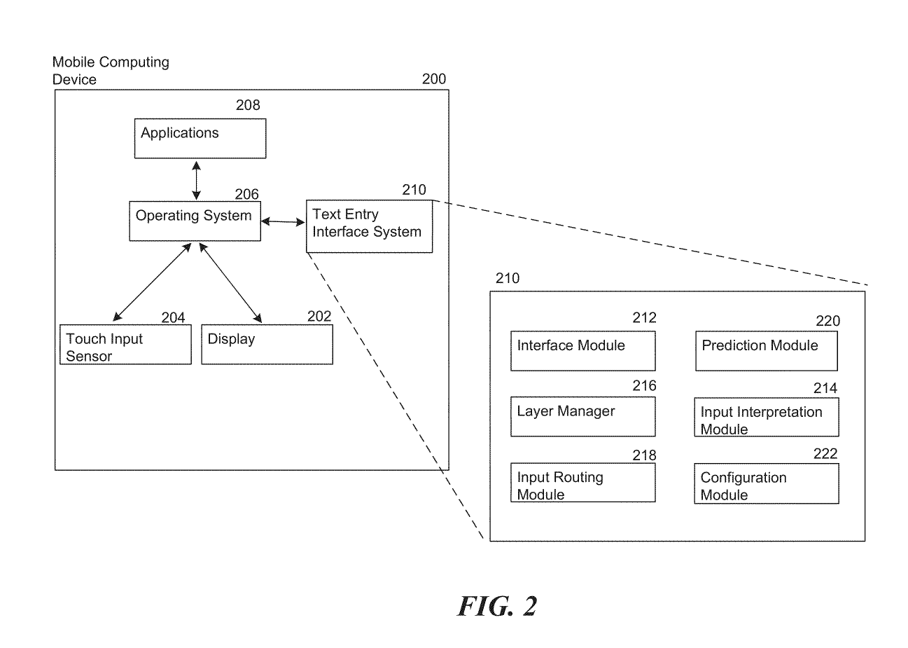

FIG. 2 is a block diagram of a mobile computing device 200, such as one of the mobile computing devices 105 of FIG. 1. The mobile computing device 200 includes a display 202 and a touch input sensor 204, both of which are operatively coupled to an operating system 206. The touch input sensor 204 may be integrated with the display in a touchscreen panel that relies on, for example, resistive, capacitive, infrared, optical, or other means to detect the location and movement of a touch on the touchscreen panel. Graphics presented on the display 202 are controlled, in part, by the operating system 206. Touch inputs to the display 202 are detected by the touch input sensor 204 and are communicated to other components of the mobile computing device 200 by the operating system 206. The operating system 206 may expose information directly from the touch input sensor 204, may communicate touch-input information only after it has been processed by the operating system and converted into, for example an X-Y coordinate or other location, or both.

Applications 208 may run or execute on the mobile computing device 200. Applications 208 may be standalone applications (e.g., a note-taking program, a word processor, a messaging program) or embedded programs that interact with the operating system 206 or other applications. Applications 208 and the operating system 206 may include elements for user interaction, such as text entry fields. The operating system 206 may simultaneously handle multiple background applications and multiple foreground applications, where the foreground applications are those being displayed. When there are multiple foreground applications 208, the operating system 206 maintains state as to which foreground application is to receive text input from a user, e.g., in which of multiple foreground applications did a user select a text entry field. The operating system 206 has means to update which of the applications 208 are foreground applications and which foreground application is to receive text input from a user. The operating system 206 also determines when an operating system feature is being displayed to a user and is to receive text input from the user.

The mobile computing system 200 additionally includes a system 210 for the generation of a transparent full-screen text entry interface. The transparent full-screen text entry interface system 210 operates in the background and is launched by the operating system 206 or by a foreground application 208 when the OS or foreground application is to receive text input. For example, the text entry interface system 210 may generate the text entry interface when a user selects a text entry field in the foreground application or when the foreground application presents a text prompt. Once the text entry interface has been launched, touch inputs detected by the touch input sensor 204 are interpreted by the text entry interface and provided to any foreground applications 208 or to the operating system 206. The text entry interface system 210 provides means through which user inputs detected by the touch input sensor 204 are translated into text for foreground applications or the OS, while still providing user visibility of and ability to interact with the underlying foreground applications or OS.

The text entry interface system 210 comprises several modules that generate the text entry interface and manage switching into and out of the interface. An interface module 212 generates a full-screen user interface that is displayed in a text entry layer to a user on display 202. The user interacts with the displayed interface and provides touch inputs that generate text for a foreground application 208 or the OS 206. User inputs are received by the interface module 212 and used to generate text when the text entry layer is the active layer. Because the interface module 212 has use of the entire display 202, a variety of different on-screen interfaces for user input may be generated. In some embodiments, the user interface is a 9-key keypad that a user may utilize to enter text. In another embodiment, user input is entered into the generated interface through user trace paths or swipes that are treated as handwriting. The interface module 212 may also display a word correction list, which presents the user with suggested current (e.g., corrected) and next words. While elements of the interface generated by the interface module 212 with which a user will interact (such as keys of an on-screen keypad, a word correction list, and function keys) are user-visible, the interface is generally transparent or semi-transparent. By generating a transparent or semi-transparent interface, an application or the OS may be rendered “below” the generated interface in the text entry layer and still be fully or partially visible. As text is generated by the user through user input or user selection of suggested words or both, the text is passed to the foreground application 208 or the operating system 206 that is to receive text input from the user.

An application layer exists “below” the text entry layer. The application layer displays the foreground applications 208 and operating system 206. Updates to the foreground applications 208 and operating system 206, such as in response to user input (e.g., a text entry field being updated with text entered in the text entry layer), are reflected in the application layer.

The layer manager 216 maintains which of the text entry layer and the application layer is the active layer and which is the inactive layer. Both the active layer and inactive layer are displayed simultaneously, with the active layer displayed over the inactive layer. Visual cues are used to distinguish between the active and inactive layers according to configuration settings. For example, in some embodiments the display of the application layer is blurred if the text entry layer is active. The layer manager 216 initially sets the text entry layer as the active layer when the transparent full-screen text entry interface is launched. A function of the layer manager 216 is to interpret user inputs and determine whether those inputs should be treated as commands directing layer manager operations (e.g., triggering an active layer switch) or whether those inputs should be treated as entered text.

The layer manager 216 detects the conditions for switching the active layer from the text entry layer to the application layer, and controls the switch. While the text entry layer is active, a user may wish to interact with the inactive application layer below. Such interaction might be for the purpose of moving a cursor in the text entry field of the foreground application 208 currently receiving text. It may also be to interact with a different user interface element, such as selecting a different text entry field, button, or menu item, in a foreground application 208. To interact with the inactive application layer, the application layer needs to be made the active layer. Certain user inputs will instruct the layer manager 216 to make the application layer active and the text entry layer inactive. In some embodiments, such user input is a long touch (i.e., press and hold). In some embodiments, such user input is a gesture. In some embodiments, such user input is a selection of an on-screen function key. In some embodiments, such user input is the input to a physical key of the mobile computing device. When the layer manager 216 detects such an input it sets the application layer as the active layer. By changing the application layer to the active layer, any user inputs following the input that triggered the layer switch will not be passed to the text entry layer.

In some embodiments, the layer manager 216 may also automatically switch to the application layer as the active layer without user command. For example, a timeout counter may be maintained by the layer manager 216. If a user has failed to enter any text via the text entry layer for a period of time (e.g., 15 second), the layer manager will automatically switch to the applications layer. A user that subsequently wants to enter text would thus need to re-launch the text entry interface.

The layer manager 216 also detects the conditions for switching the active layer from the application layer to the text entry layer, and controls the switch. While the application layer is active, a user is able to interact with the foreground applications 208 and OS 206, which may include moving a cursor, selecting a menu item, closing a foreground application, opening a new foreground application, and so on. User inputs will not be sent to the text entry layer, and thus not be used for the purpose of generating text, until the text entry layer is restored as the active layer by the layer manager 216. In some embodiments, the text entry layer is restored as the active layer in response to a user input, such as the selection of an on-screen key, a touch gesture, or an input to a physical key. In some embodiments, the layer manager 216 restores the text entry layer as the active layer after selecting a field into which text is to be entered.

The layer manager 216 further detects conditions for terminating generation of the text entry interface. In some embodiments, the layer manager 216 terminates generation of the text entry interface in response to a user input, such as the selection of an on-screen key, a touch gesture, or an input to a physical key. In some embodiments, the layer manager 216 terminates generation of the text entry interface after the expiration of a timeout period during which the user provides no input. Once the transparent full-screen text entry interface has been terminated, operating system 206 functions, such as passing information regarding user inputs to applications 208, behave as they did prior to the launch of the transparent full-screen text entry interface.

The text entry interface system 210 includes an input routing module 218, which receives user inputs from the layer manager 216. The input routing module 218 routes received inputs according to the current active layer. When the text entry layer is active, inputs received by the input routing layer 218 are passed to the text entry layer, where they will be used to determine interaction with the text entry layer (e.g., tap of an on-screen key, handwriting trace paths, selection of a word in the word correction list). When the application layer is active, inputs received by the input routing layer 218 are passed to the operating system 206 or to foreground applications 208.

The text entry interface system 210 includes a prediction module 220, which generates suggested words for use in the word correction list displayed in the text entry layer. The prediction module 220 may generate suggested words for an in-progress word (including corrections) or a next word.

The text entry interface system 210 additionally includes an input interpretation module 214, which translates user inputs to the text entry layer into text for a text field or word prediction module. The input interpretation module 214 operates according to the user input interface currently being used for text entry. When the handwriting interface is enabled, the input interpretation module 214 treats user swipes or trace paths from a finger or stylus as handwriting and translates that handwriting to text. When the 9-key keypad interface is enabled, the input interpretation module 214 translates user inputs to the pressed key on the on-screen keypad to an appropriate character or characters. The input interpretation module 214 may translate pressed keys to text according to multi-tap input semantics or single press (predictive) input semantics.

The text entry interface system 210 further includes a configuration module 222, which allows the user of the mobile computing device 200 to configure elements of the transparent full-screen text entry interface. The configuration module 222 may allow selecting the form of input method used by the text entry layer. For example, a user may select between an on-screen 9-key keypad or handwriting recognition of user swipes for text input. The configuration module 222 may allow selecting how the layer manager 216 determines switching the current active layer. For example, a user may specify that an on-screen function key to be used to direct an active layer switch, or a user may specify that a swipe gesture to be used to direct an active layer switch. In some embodiments a user may specify the use of or duration of a timeout, wherein the layer manager 216 will initiate an active layer switch if no user input is received at the expiration of a period of time. In some embodiments a user may specify that a long press, such as a touch and hold, will be used to direct an active layer switch. Certain options may only be available for switching the active layer to the text entry layer, certain options may only be available for switching the active layer to the application layer, and certain options may be available for both. The configuration module 222 may also allow a user to select options for visual cues used to differentiate the current active layer from current inactive layer. In some embodiments the inactive layer may be displayed faded. In some embodiments the inactive layer may be displayed blurred. In some embodiments the inactive layer may be displayed with differently colored interface elements. For example, the inactive layer may be displayed in black and white. Banner text or an icon may be displayed by the interface system 210 to indicate which layer is active (such as “KB” when the text entry layer is active and “APP” when the application layer is active).

### Flows for a Transparent Full-Screen Text Entry Interface

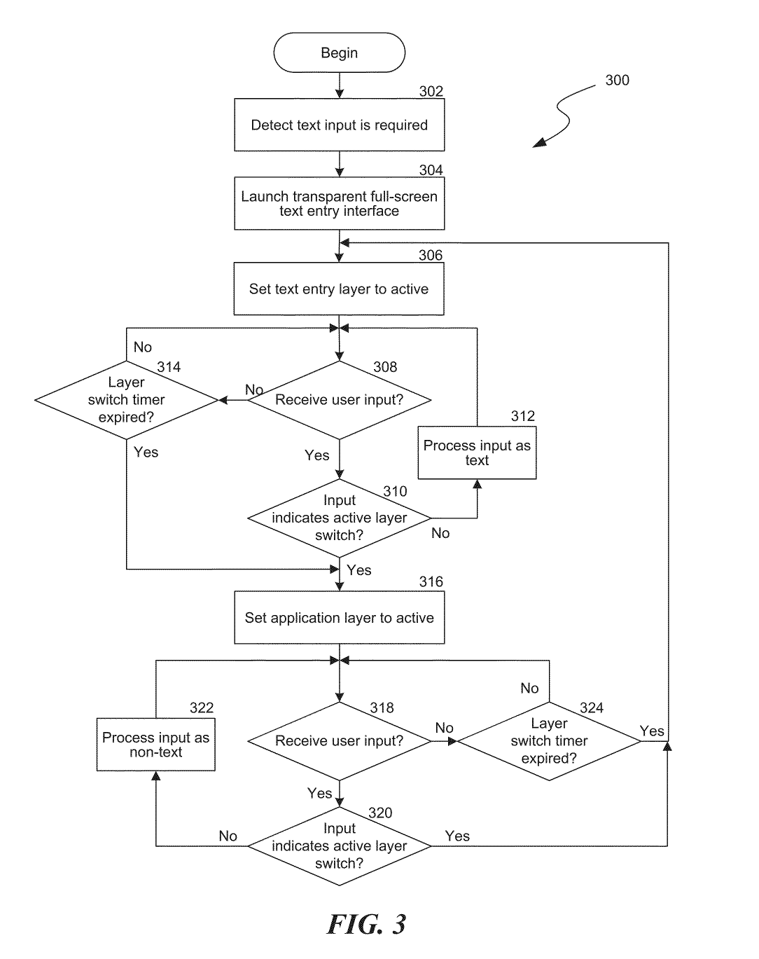

FIG. 3 is a flowchart illustrating an example process 300 for switching input modes for a transparent full-screen text entry interface on a mobile computing device. At a block 302, the text entry interface system 210 determines that text input is to be received from a user. Text input may be expected in response to the user selecting a text entry field. Text input may also be expected in response to an application prompting a user for text input. At a block 304, the text entry interface system launches a transparent full-screen text entry interface to receive user input. Launching the text entry interface includes initializing a text entry layer and an application layer. At a block 306, the text entry interface system sets the text entry layer to the active layer.

At a decision block 308, the text entry interface system determines whether any user input, such as through a touchscreen of the device, has been received. If user input has been received, processing proceeds to a decision block 310, which interprets the user input. If user input has not been received, processing continues to a decision block 314, which manages timeout evaluations.

At the decision block 310, the interface system 210 evaluates received user input to determine whether the input indicates an active layer switch. In some embodiments, user input comprising a long press indicates a command to switch active layers. In some embodiments, a particular received gesture from a user indicates a command to switch active layers. In some embodiments, an input to a physical key on the mobile computing device indicates a command to switch active layers. If the received user input indicates an active layer switch at decision block 310, processing proceeds to a block 316 where the system sets the application layer to the active layer. If the received user input does not indicate an active layer switch at decision block 310, the system processes the input to generate text at a block 312.

At block 312, the system translates user input to text according to the enabled input interface. When the handwriting interface is enabled, user swipes or trace paths are treated as handwriting and translated to text. When the 9-key keypad interface is enabled, user inputs corresponding to the pressed key on the on-screen keypad are translated to text. Translated text may then be used to generate word predictions, enabling the system to suggest words to the user for replacing the in-progress word or selecting a next word. It will be appreciated by one skilled in the art that several techniques can be used to predict a word according to input text and to present suggested words. For example, the system may employ prediction techniques such as those described in U.S. patent application Ser. No. 13/189,512 entitled REDUCED KEYBOARD WITH PREDICTION SOLUTIONS WHEN INPUT IS A PARTIAL SLIDING TRAJECTORY or U.S. Patent Application No. @@@ entitled USER GENERATED SHORT PHRASES FOR AUTO-FILLING, AUTOMATICALLY COLLECTED DURING NORMAL TEXT USE. Generated text, either translated from user input or selected from a list of suggested words, is then passed from the transparent full-screen text entry interface system 210 to the operating system 206 such that the text is displayed in the application layer. Text may be passed to the operating system 206 at different granularities, for example on a character-by-character basis or at the end of a word. Once the transparent full-screen text entry interface system 210 has processed the input at the block 312, the system returns to the decision block 308 for further polling of received user input.

If no user input is received at the decision block 308, the transparent full-screen text entry interface proceeds to the decision block 314 for a timeout evaluation. At the decision block 314, the text entry interface system evaluates whether a layer switch timer has expired. If the layer switch timer has not expired, then the transparent full-screen text entry interface returns to the decision block 308 for further polling of received user input. If the layer switch timer has expired, then processing proceeds to the block 316 where the interface system sets the application layer to be the active layer.

After setting the application layer to the active layer at the block 316, the interface system proceeds to a decision block 318, where the system determines if user input has been received. If user input has been received, processing proceeds to a decision block 320, which interprets the user input. If user input has not been received, processing continues to a decision block 324, which manages timeout evaluations.

At the decision block 320, the interface system 210 evaluates received user input to determine whether the input indicates an active layer switch. If the received user input indicates an active layer switch at decision block 320, processing returns to block 306 where the system sets the text entry layer to the active layer. If the received user input does not indicate an active layer switch at decision block 320, the system processes the input to at a block 322. The input may be interpreted, for example, as a selection of a control (e.g., a drop-down menu, a button), an interface command (e.g., a pinch to indicate a change in size, a swipe to indicate a change in page), or other function. The transparent full-screen text entry interface system then returns to the decision block 318 for further polling of received user data.

If no user input is received at the decision block 318, the transparent full-screen text entry interface proceeds to the decision block 324 for a timeout evaluation. At the decision block 324, the text entry interface system evaluates whether a layer switch timer has expired. If the layer switch timer has not expired, then the transparent full-screen text entry interface returns to the decision block 318 for further polling of received user input. If the layer switch timer has expired, then processing proceeds to block 306 where the interface system sets the application layer to be the active layer.

The process 300 continues to loop through iterations of polling for user input, evaluating user input for active layer change commands and, in the absence of user input, evaluating timeout conditions. It will be appreciated that under certain conditions, it may be desirable to have the process 300 terminate. Termination of the process may be caused by an explicit user command, expiration of a sufficient period of non-use of the device, or other mechanism known to those skilled in the art.

### Example User Displays

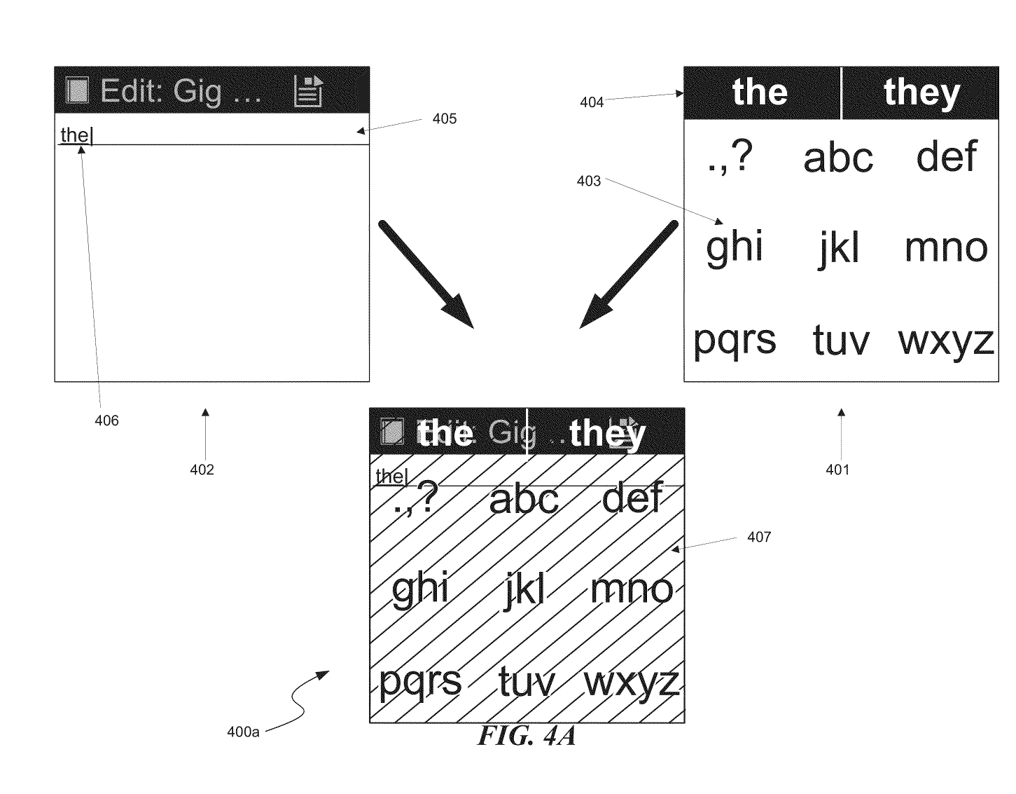

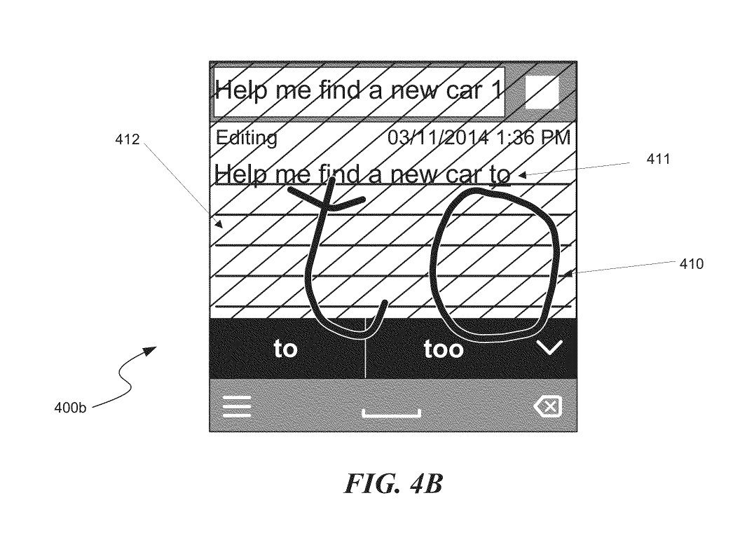

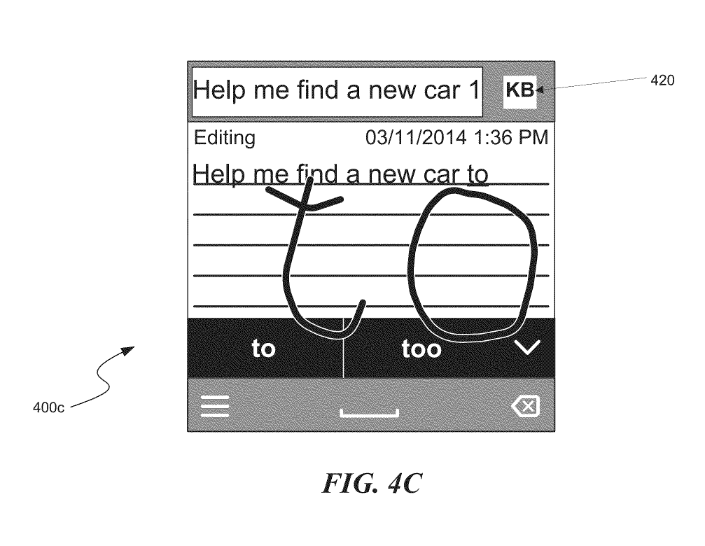

FIGS. 4A, 4B, and 4C illustrate example graphical interfaces 400a, 400b, and 400c, such as may be generated by the text entry interface system 210. Referring to FIG. 4A, the graphical interface 400a includes an active text entry layer 401 in the foreground and an inactive application layer 402 in the background, also shown separately for illustrative purposes only. The text entry layer 401 includes a 9-key keypad 403, which a user can use to enter keystrokes for text entry. The text entry layer also includes a word correction list 404, which provides word suggestions for in-progress and next words. The text entry layer 401 is transparent such that the application layer 402 may be viewed beneath the text entry layer. The application layer 402 includes a text entry field 405, which is the target of user inputted text. The text entry layer 401 is activated by a user first selecting the text entry field 405 as an indication that they are going to enter text. Text 406 that has been input by a user using the text entry layer 401 is reflected in the text entry field 405. The application layer 402 is further rendered with an effect 407, such as conversion to black and white, to distinguish it from the active text entry layer 401.

FIG. 4B illustrates an alternative graphical interface 400b that may be generated by the text entry interface system 210. Rather than a keyboard, the text entry layer in interface 400b allows a user to use script to enter text. For example, the user may use a finger or a stylus to write letters 410 on the text entry layer. The entirety of the display may be used for the entry of characters, meaning that the user can utilize all of the visible region of the display to form the entered characters. Characters entered in such a fashion are translated by the text entry interface 210 into text for a text entry field 411 in the underlying application layer. The application layer is rendered with an effect 412, which serves as a visual cue indicating that the text entry layer is the active layer.

FIG. 4C illustrates still another alternative graphical interface 400c that uses a visual cue to indicate to a user which of the text entry layer and application layer is the active layer. An icon 420 displaying the text “KB,” for keyboard, indicates to the user that the text entry layer, or keyboard, is the active layer of the text entry interface. If the user enters the text entry layer and the application layer becomes active, the “KB” text is removed from the screen.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A computer-implemented method for generating an interface to enable text entry on a mobile device, the method comprising:
receiving a first input from a user indicating a desire to enter text on a mobile device having a touch-sensitive display screen;
enabling a transparent or semi-transparent interface to facilitate text entry,
wherein the interface extends over the entirety of the display screen,
wherein an underlying application is viewable by the user through the interface, and
wherein the interface is configured to receive text over the entirety of the display screen for the underlying application from a user input;
receiving a second input from the user;
determining whether the received second input indicates a desire to enter text in the underlying application or indicates a desire to interact with the underlying application;
generating text from the second input when it is determined that the second input indicates a desire to enter text in the underlying application; and
disabling the interface and returning to the underlying application when it is determined that the second input indicates a desire to interact with the underlying application.

2. The method of claim 1, further comprising:
receiving a third input indicating a desire to enter text on the mobile device; and
re-enabling the interface in response to the third input.

3. The method of claim 1, further comprising disabling the interface when the second input is not received within a threshold period after receipt of the first input.

4. The method of claim 1, wherein the first input or the second input is not received by the touch-sensitive display screen.

5. The method of claim 1, wherein visual characteristics of the underlying application are modified when the interface is enabled.

6. The method of claim 5, wherein the underlying application is blurred, faded, or presented in a different color.

7. The method of claim 1, wherein the second input is a trace path representing handwriting, and wherein generating text from the second input comprises translating the trace path to text.

8. The method of claim 1, wherein the interface includes an on-screen keypad and wherein the second input is comprised of keyed input by the user.

9. The method of claim 8, wherein the second input is further comprised of a trace path input.

10. The method of claim 1, wherein the desire to interact with the underlying application is indicated by a press and hold input.

11. A system including at least one processor and memory for generating an interface to enable text entry on a mobile device, the system comprising:
an interface module configured to:
enable a transparent or semi-transparent interface to facilitate text entry on a mobile device having a touch-sensitive display screen,
wherein the interface extends over the entirety of the display screen,
wherein an underlying application is viewable by a user through the interface, and
wherein the interface is configured to receive text over the entirety of the display screen for the underlying application; and
receive an input from the user;
a layer manager configured to:
determine whether the received input indicates a desire to enter text in the underlying application or indicates a desire to interact with the underlying application; and
disable the interface and return to the underlying application when it is determined that the received input indicates a desire to interact with the underlying application; and
an input interpretation module configured to:
generate text from the received input when it is determined that the received input indicates a desire to enter text in the underlying application.

12. The system of claim 11, wherein the system further comprises a prediction module configured to predict a next word or a corrected word based on the generated text.

13. The system of claim 11, wherein the interface module is further configured to re-enable the interface in response to a second user input.

14. The system of claim 11, wherein the layer manager is further configured to disable the interface and return to the underlying application when the received input is not received within a threshold period after the interface is enabled.

15. The system of claim 11, wherein the interface module is further configured to modify visual characteristics of the underlying application when the interface is enabled.

16. The system of claim 11, wherein the received input is a trace path representing handwriting, and wherein generating text from the received input comprises translating the trace path to text.

17. The system of claim 11, wherein the interface includes an on-screen keypad, and wherein the received input is comprised of keyed input by the user.

18. The system of claim 17, wherein the received input is further comprised of a trace path input.

19. A tangible computer-readable storage medium containing instructions for performing a method for generating an interface to enable text entry on a mobile device, the method comprising:
receiving a first input from a user indicating a desire to enter text on a mobile device having a touch-sensitive display screen;
enabling a transparent or semi-transparent interface to facilitate text entry,
wherein the interface extends over the entirety of the display screen,
wherein an underlying application is viewable by the user through the interface, and
wherein the interface is configured to receive text over the entirety of the display screen for the underlying application from a user input;
receiving a second input from the user;
determining whether the received second input indicates a desire to enter text in the underlying application or indicates a desire to interact with the underlying application;
generating text from the second input when it is determined that the second input indicates a desire to enter text in the underlying application;
disabling the interface and returning to the underlying application when it is determined that the second input indicates a desire to interact with the underlying application;
disabling the interface and returning to the underlying application when the second input is not received within a threshold period after receipt of the first input;
receiving a third input indicating a desire to enter text on the mobile device; and
re-enabling the interface in response to the third input.

20. The computer-readable storage medium of claim 19, wherein the second input is a trace path representing handwriting, and wherein generating text from the second input comprises translating the trace path to text.

21. The computer-readable storage medium of claim 19, wherein the interface includes an on-screen keypad and wherein the second input is keyed input by the user.

22. The computer-readable storage medium of claim 19, wherein the desire to interact with the underlying application is indicated by a press and hold input.
